(19) United States
(12) Patent Application Publication
(10) Pub. No.: US 2010/0146810 A1
(43) Pub. Date: Jun. 17, 2010

(54) CONDITIONING APPARATUS FOR THE AIR SUPPLY STREAM OF A DRYING CHAMBER OF AN ENAMELING LINE AND A METHOD FOR CONDITIONING THE AIR SUPPLY STREAM

(76) Inventor: Norbert Struensee, Essen (DE)

Correspondence Address: KF ROSS PC, 5683 RIVERDALE AVENUE, SUITE 203 BOX 900, BRONX, NY, 10471-0900, US

(21) Appl. No.: 12/515,430

(22) PCT Filed: Oct. 19, 2007
(86) PCT No.: PCT/EP2007/009072

§ 371 Date: May 19, 2009

(30) Foreign Application Priority Data
Nov. 20, 2006 (DE) 102006054875.2

(51) Int. Cl. F26B 3/02; F26B 21/06; B05B 15/12; F25B 15/00

(52) U.S. Cl. 34/472; 34/80; 454/50; 62/271

(57) ABSTRACT

A conditioning apparatus (1) for the air supply stream of a drying chamber (2) of an enameling line has a fresh air duct (8) and an air supply duct (10) connected thereto through which a fresh air or air supply stream can be directed into the drying chamber (2); an exhaust air duct (13) and an escaping air duct (14) connected thereto through which an exhaust air stream can be guided out of the drying chamber (2) or out of an escaping air duct into the surrounding area; an absorption or adsorption device (4) which is arranged in the escaping air duct (14) and in the air supply duct (10) and in which the air supply stream can be dehumidified and heated to a predetermined level of humidity by means of the escaping air stream; a device for heat recovery (6) which is arranged upstream of the absorption or adsorption device (4) in the escaping air duct (14) and which is arranged downstream of the absorption or adsorption device (4) in the air supply duct (10) and in which the air supply stream which is dehumidified and heated in the absorption or adsorption device (4) by means of the escaping air stream emitted from the drying chamber (2) can be cooled; an aftercooler (7) which is arranged downstream of the heat recovery device (6) in the air supply duct (10) and in which the air supply stream which is precooled in the heat recovery device (6) can be cooled to a temperature required for entry into the drying chamber (2); and an afterheater (5) which is arranged in the escaping air duct (14) downstream of the heat recovery device (6) and upstream of the absorption or adsorption device (4) and in which the escaping air stream can be heated to a temperature suitable for the regeneration of the absorption or adsorption device (4). To reduce the use of energy for the operation of the conditioning apparatus (1), it is suggested that a recirculating air duct (11) branch off from the exhaust air duct (13) coming out of the drying chamber (2) at a first junction place (12); and that through said recirculating air duct, a part of the exhaust air stream coming out of the drying chamber (2) can be brought, together with the fresh air stream, as a recirculating air stream in a second junction place (9), and can then be directed through the air supply duct (10) as an air supply stream into the drying chamber (2); and that a precooler (3), by means of which the fresh air stream can be cooled and dehumidified, is arranged upstream of the second junction place (9) in the fresh air duct (8).

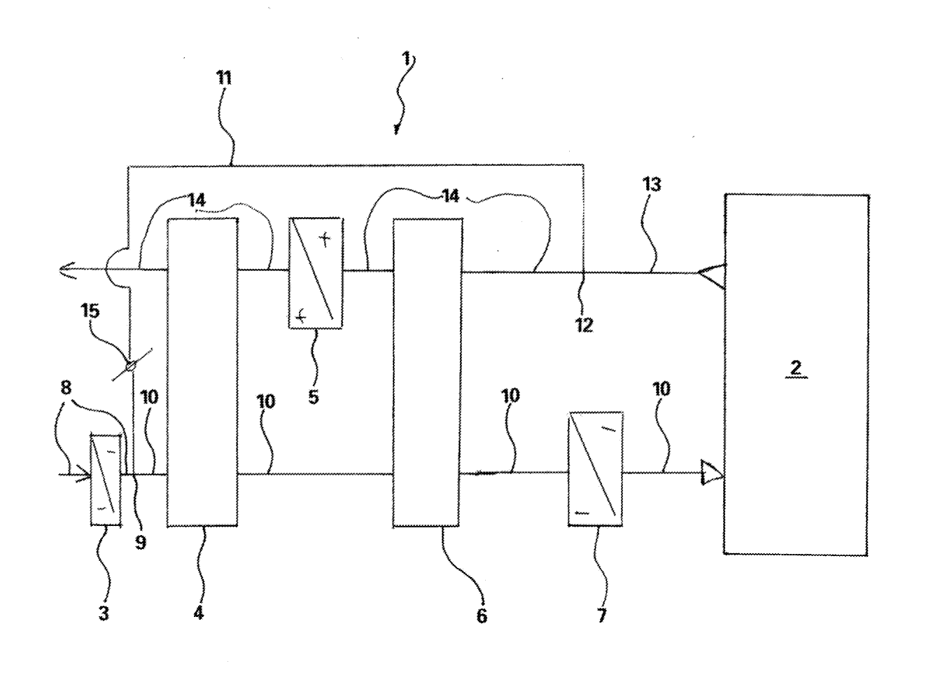

The invention relates to a conditioning device for the supply air stream of a drying chamber of a painting installation, with an external air duct and a supply air duct which connects thereto, through which ducts an external air stream and a supply air stream can be introduced into the drying chamber, an exhaust air duct and an outgoing air duct which connects thereto, through which ducts an exhaust air stream can be discharged out of the drying chamber and an outgoing air stream can be discharged to the environment, an absorption and adsorption device, which is arranged in the outgoing air duct on the one hand and in the supply air duct on the other hand and in which the supply air stream can be dehumidified and heated to a predetermined moisture content by means of the outgoing air stream, a heat recovery device, which is arranged upstream of the absorption and adsorption device in the outgoing air duct on the one hand and downstream of the absorption and adsorption device in the supply air duct on the other hand and in which the supply air stream dehumidified and heated in the absorption and adsorption device can be cooled by means of the outgoing air stream which has emerged from the drying chamber, an aftercooler, which is arranged in the supply air duct downstream of the heat recovery device and in which the supply air stream precooled in the heat recovery device can be cooled to a temperature required when it enters the drying chamber, and an afterheater, which is arranged in the outgoing air duct downstream of the heat recovery device and upstream of the absorption and adsorption device and in which the outgoing air stream can be heated to a temperature suitable for the regeneration of the absorption and adsorption device. Correspondingly, the invention relates to a method for conditioning the supply air stream of a drying chamber of a painting installation, in which an external air or supply air stream is introduced into the drying chamber, an exhaust air or outgoing air stream is discharged out of the drying chamber to the environment, the supply air stream is dehumidified and heated in an absorption and adsorption device to a predetermined moisture content by means of the outgoing air stream, the supply air stream dehumidified and heated in the absorption and adsorption device is cooled in a heat recovery device by means of the outgoing air stream which has emerged from the drying chamber, the supply air stream cooled in the heat recovery device is cooled to a temperature required when it enters the drying chamber in an aftercooler, and the outgoing air stream is heated to a temperature suitable for the regeneration of the absorption and adsorption device in an afterheater between the heat recovery device and the absorption and adsorption device.

Starting from the previously indicated prior art, the object of the invention is to develop the conditioning device of the generic type and the conditioning method of the generic type in such a manner that the operation of the conditioning device or the carrying out of the conditioning method is possible with an energy use which is reduced considerably compared to the prior art.

This object is achieved with respect to the previously indicated conditioning device in that, at a first branching point, a circulating air duct branches off from the exhaust air duct which emerges from the drying chamber, through which circulating air duct a portion of the exhaust air stream emerging from the drying chamber can be merged as circulating air stream with the external air stream at a second branching point and then introduced into the drying chamber though the supply air duct as the supply air stream, and in that a precooler is arranged in the external air duct upstream of the second branching point, by means of which precooler the external air stream can be cooled and dehumidified; with respect to the previously mentioned method of the generic type, the object of the invention is achieved in that a circulating air stream is branched off from the exhaust air stream emerging from the drying chamber, is then merged with the external air stream to form the supply air stream and is introduced into the drying chamber through the absorption and adsorption device, the heat recovery device and the aftercooler, and in that the external air stream is precooled in a precooler before the merging with the circulating air stream. The external air stream is conditioned by means of the precooler in such a manner that it assumes a state, together with the circulating air stream branched off from the exhaust air duct, which allows the supply air stream consisting of the external air stream and the circulating air stream to be dried to the desired moisture content of the supply air stream in the following absorption and adsorption device. The regeneration of the absorption and adsorption device is realized by means of the outgoing air stream which is branched out of the exhaust air stream subsequent to the preheating of the outgoing air stream by means of the heat recovery device and an afterheater. In the conditioning device according to the invention or in the case of the conditioning method according to the invention, quasi-conditioned exhaust air is accordingly used in order to regenerate the absorption and adsorption device which is used for the conditioning of the supply air stream. The supply air stream heated in the drying process, which takes place in the absorption and adsorption device, is precooled in the heat recovery device with the cooling potential of the non-heated outgoing air stream which has emerged from the drying chamber. After this precooling procedure, the supply air stream is cooled in an aftercooler to the temperature required or desired when it enters the drying chamber.

A considerably reduced energy use results for the refrigeration as well as the regeneration of the absorption and adsorption device in comparison with conventional devices and methods of this type. A complete conditioning is only necessary for that portion of the supply air stream which is introduced into the conditioning device in the form of the external air stream. Only a partial conditioning is necessary with respect to the circulating air stream. Furthermore, the exchange of the air required in the drying chamber for the drying procedure is limited to the amount necessary from the point of view of process engineering.

According to an advantageous embodiment of the device according to the invention, the precooler provided in the external air duct and/or the aftercooler provided in the supply air duct are connected to the afterheater arranged in the outgoing air duct in the cooling/heating network; accordingly, in an advantageous embodiment of the method according to the invention, the outgoing air stream is heated to the temperature suitable for the regeneration of the absorption and adsorption device upstream of the absorption and adsorption device by means of waste heat produced in the pre- and/or aftercooler, as a result of which, a further reduction of the regeneration energy requirement is achieved. The absorption and adsorption device can advantageously be constructed as a sorption rotor or wheel, wherein the one sector of the sorption rotor or wheel is assigned to the outgoing air duct and the other sector of the sorption rotor or wheel is assigned to the supply air duct.

Insofar as the output of the heat recovery device can be regulated during the operation of the conditioning device according to the invention or during the carrying out of the conditioning method according to the invention, the waste heat produced during the refrigeration can be removed in a satisfactory manner.

According to a further advantageous embodiment of the conditioning device according to the invention, at least one heat exchanger is integrated in the outgoing air duct, by means of which heat exchanger, waste heat produced during the refrigeration in the conditioning device can be discharged from the conditioning device. In a corresponding development of the method according to the invention, waste heat produced is transmitted into the outgoing air stream by means of heat exchangers and removed. Thus, a further possibility is available for discharging heat from the conditioning device, in addition to the output regulation of the heat recovery device.

According to a further advantageous embodiment of the conditioning device according to the invention, the precooler and/or the aftercooler are/is constructed as a direct heat exchanger. The afterheater can, in the case of a corresponding requirement profile, be constructed in two stages, wherein the afterheater or the first and/or the second stage of the afterheater can be constructed as a condenser. In the case of this configuration of the precooler, the aftercooler and the afterheater, the inclusion of an external cooling agent can be dispensed with, wherein the process heat released in the cooling process can be incorporated in the drying process at the same time.

A particularly advantageous embodiment of the conditioning method according to the invention results when the supply air stream consists of approx. 25 to 37%, preferably of approx. 31% circulating air and of approx. 63 to 75%, preferably of approx. 69% external air.

According to a further advantageous embodiment of the conditioning device according to the invention, a control valve is arranged in the circulating air duct, by means of which valve the volume flow of the circulating air stream can be controlled or regulated during the carrying out of the method according to the invention. Thereby, an adjustment of the ratio between the circulating air stream and the external air stream can be set in a quasi-infinitely variable manner depending on changes in the method parameters or in the requirement profile.

An energy saving of up to 40% in comparison with the prior art can be achieved by means of the conditioning device configured according to the invention or the correspondingly configured method.

In the following, the invention is explained in more detail on the basis of an embodiment and with reference to the drawing, the single figure of which shows a schematic representation of a conditioning device for the supply air stream according to the invention of a drying chamber of a painting installation.

An embodiment, shown in the single figure, of a conditioning device 1 according to the invention is used to condition the supply air stream of a drying chamber 2 of a paint installation, which is not shown further, in such a manner that, when it enters the drying chamber 2, the supply air conforms with the requirements which are in place in the drying process which takes place in the drying chamber 2, particularly with respect to its moisture content and its temperature. In the exemplary embodiment shown in the figure, the nominal moisture content of the supply air when entering the drying chamber 2 is 1.3 g/kg, the nominal temperature is 30° C. The volume of the supply air stream is 43000 m³/h.

The conditioning device 1 has a precooler 3, an absorption and adsorption device 4, an afterheater 5, a heat recovery device 6 and an aftercooler 7 for conditioning this supply air stream in the desired manner.

In the exemplary embodiment shown, the precooler 3 is formed as a direct heat exchanger and arranged in an external air duct 8 through which an external air stream is introduced into the conditioning device 1. In the exemplary embodiment shown, the external air stream has a volume of 29500 m³/h, a temperature of 35° C. and a moisture content of 22 g/kg. Downstream of the aftercooler 7, the external air duct 8 changes into a supply air duct 10 at a branching point 9. At the branching point 9, the external air duct 8 and a circulating air duct 11 join to form the supply air duct 10. Accordingly, the external air stream is merged with a circulating air stream to form the supply air stream at the branching point 9. The circulating air stream has a volume of 13500 m³/h, a moisture content of 3.5 g/kg and a temperature of 25° C. The supply air stream consisting of the external air stream precooled and dehumidified in the precooler 3 and the circulating air stream has a temperature of approx. 17 to 18° C. and a moisture content of approx. 8 g/kg downstream of the branching point 9.

The circulating air duct 11 ends at its opposite end to the branching point 9 in a further branching point 12, into which an exhaust air duct 13 opens at the inlet side, which exhaust air duct branches into the circulating air duct 11 and an outgoing air duct 14 at the branching point 12. An exhaust air stream is conveyed out of the drying chamber 2 to the branching point 12 through the exhaust air channel 13. At the branching point 12, the exhaust air stream is divided into an outgoing air stream and the circulating air stream. In the exemplary embodiment shown, the exhaust air stream has a moisture content of approx. 3.5 g/kg, a temperature of 25° C. and a volume of approx. 35000 m³/h. The volume difference between the supply air stream and the exhaust air stream arises due to losses occurring during the drying process in the drying chamber 2.

Downstream of the branching point 12, the outgoing air stream flows through the outgoing air duct 14 with a volume of approx. 21500 m³/h.

The absorption and adsorption device 4 is arranged downstream of the branching point 9 in the supply air duct 10. The absorption and adsorption device 4 is constructed as a sorption rotor or wheel in the exemplary embodiment shown and as well as being arranged in the supply air channel 10 is also arranged downstream of the afterheater 5 in the outgoing air duct 14. In the region of the absorption and adsorption device 4 which is assigned to the supply air duct 10, the supply air stream is heated to a temperature of approx. 50° C. and dehumidified to a moisture content of approx. 1.3 g/kg.

The heat recovery device 6 is arranged downstream of the absorption and adsorption device 4 in the supply air duct 10 and another section of the heat recovery device is arranged upstream of the afterheater 5 in the outgoing air duct 14. In the heat recovery device 6, the supply air stream is cooled from 50° C. to approx. 38 to 40° C. while its moisture content is kept constant to the greatest extent possible. To this end, the outgoing air stream, which has the temperature 25° C. before entering the heat recovery device 6, is heated in the heat recovery device 6.

The aftercooler 7 is arranged downstream of the heat recovery device 6 in the supply air duct 10, by means of which aftercooler the supply air stream is cooled from 38 to 40° C. to the temperature desired for the entrance into the drying chamber 2 of approx. 30° C. while keeping the moisture content constant at 1.3 g/kg. The aftercooler 7 is constructed, as is the precooler 3, as a direct heat exchanger in the exemplary embodiment shown.

The heat recovery device 6 is configured such that it can be regulated in the exemplary embodiment shown in order to guarantee the satisfactory heat removal of the refrigeration.

The afterheater 5 arranged in the outgoing air duct downstream of the heat recovery device 6 and upstream of the absorption and adsorption device 4 can, in the case of a corresponding requirement profile, be constructed in two stages, wherein a configuration of the afterheater 5 or its two stages as a condenser is expedient. In the afterheater 5, the temperature of the outgoing air stream is set in such a manner that it is sufficient for the regeneration of the absorption and adsorption device 4, by means of which the supply air stream is heated to 50° C. and the target moisture content of 1.3 g/kg is set.

When exiting the absorption and adsorption device 4, the outgoing air stream in the exemplary embodiment shown has a moisture content of 17 g/kg and a temperature of 51° C., wherein its volume is 21500 m³/h as before.

In the exemplary embodiment shown, a control valve 15 is provided in the circulating air duct 11, by means of which control valve the volume of the circulating air stream and therefore indirectly the proportion of circulating air stream and of the outgoing air stream in the exhaust air stream can be set.

In the case of the exemplary embodiment shown, the precooler 3 provided in the external air duct 8 and the aftercooler 7 provided in the supply air duct 10 are connected to the afterheater 5 arranged in the outgoing air duct 14 in the cooling/heating network, so that the waste heat produced during the cooling can be used to heat the outgoing air stream upstream of the absorption and adsorption device.

1. A conditioning device for the supply air stream of a drying chamber of a painting installation, the device comprising:
an external air duct and a supply air duct which connects thereto, through which ducts an external air stream and a supply air stream can be introduced into the drying chamber,
an exhaust air duct and an outgoing air duct which connects thereto, through which ducts an exhaust air stream can be discharged out of the drying chamber and an outgoing air stream can be discharged to the environment,
an absorption and adsorption device which is arranged in the outgoing air duct on the one hand and in the supply air duct on the other hand and in which the supply air stream can be dehumidified and heated to a predetermined moisture content by means of the outgoing air stream,
a heat recovery device, which is arranged upstream of the absorption and adsorption device in the outgoing air duct on the one hand and downstream of the absorption and adsorption device in the supply air duct on the other hand and in which the supply air stream dehumidified and heated in the absorption and adsorption device can be cooled by means of the outgoing air stream which has emerged from the drying chamber,
an aftercooler, which is arranged in the supply air duct downstream of the heat recovery device and in which the supply air stream precooled in the heat recovery device can be cooled to a temperature required when it enters the drying chamber,
an afterheater, which is arranged in the outgoing air duct downstream of the heat recovery device and upstream of the absorption and adsorption device and in which the outgoing air stream can be heated to a temperature suitable for the regeneration of the absorption and adsorption device,
at a first branching point, a circulating air duct branching off from the exhaust air duct which emerges from the drying chamber, through which circulating air duct a portion of the exhaust air stream emerging from the drying chamber can be merged as circulating air with the external air stream at a second branching point and then introduced into the drying chamber though the supply air duct as the supply air stream, and
a precooler in the external air duct upstream of the second branching point, by means of which precooler the external air stream can be cooled and dehumidified.

2. The conditioning device according to claim 1 wherein the precooler provided in the external air duct and/or the aftercooler provided in the supply air duct are connected to the afterheater arranged in the outgoing air duct in the cooling/heating network.

3. The conditioning device according to claim 1 wherein the absorption and adsorption device is constructed as a sorption rotor or wheel.

4. The conditioning device according to claim 1 wherein the output of the heat recovery device can be regulated.

5. The conditioning device according to claim 1 wherein at least one heat exchanger is integrated in the outgoing air duct, by means of which heat exchanger, waste heat produced during the refrigeration in the conditioning device can be discharged from the conditioning device.

6. The conditioning device according to claim 1 wherein the precooler or the aftercooler is constructed as a direct heat exchanger.

7. The conditioning device according to claim 1 in wherein the afterheater is constructed in two stages.

8. The conditioning device according to claim 1 wherein the afterheater or the first or the second stage of the afterheater is constructed as a condenser.

9. The conditioning device according to claim 1 wherein a control valve is arranged in the circulating air duct.

10. A method for conditioning the supply air stream of a drying chamber of a painting installation, the method comprising the steps of:
introducing an external air or supply air stream is introduced into the drying chamber,
discharging an exhaust air or outgoing air stream from the drying chamber to the environment,
dehumidifying and heating the supply air stream in an absorption and adsorption device to a predetermined moisture content by means of the outgoing air stream,
cooling the supply air stream dehumidified and heated in the absorption and adsorption device in a heat recovery device by means of the outgoing air stream which has emerged from the drying chamber,
cooling the supply air stream cooled in the heat recovery device to a temperature required when it enters the drying chamber in an aftercooler,
heating the outgoing air stream to a temperature suitable for the regeneration of the absorption and adsorption device in an afterheater between the heat recovery device and the absorption and adsorption device,
diverting a circulating air stream from the exhaust air stream emerging from the drying chamber,
merging the diverted air stream with the external air stream to form the supply air stream, and is introduced into the drying chamber through the absorption and adsorption device, the heat recovery device and the aftercooler, and
precooling the diverted air stream in a precooler before merging with the circulating air stream.

11. The method according to claim 10 wherein the outgoing air stream is heated to the temperature suitable for the regeneration of the absorption and adsorption device upstream of the absorption and adsorption device by means of waste heat produced in the pre- or aftercooler.

12. The method according to claim 10 wherein the output of the heat recovery device is regulated.

13. The method according to claim 10 wherein waste heat produced is transmitted into the outgoing air stream by means of heat exchangers and removed.

14. The method according to claim 10 wherein the supply air stream consists of approx. 25 to 37% circulating air and of approx. 63 to 75% external air.

15. The method according to claim 10, wherein the volume flow of the circulating air stream is controlled or regulated.
